(19) United States
(12) Patent Application Publication
(10) Pub. No.: US 2009/0024404 A1
(43) Pub. Date: Jan. 22, 2009

(54) ENHANCED REAL ESTATE LISTINGS VIA MULTIPLE DEVICES

(75) Inventors: D. Beau MORLEY, Somerville, MA (US); Hannah Y. Moon, Boston, MA (US); Andrew J. Afram, Somerville, MA (US)

Correspondence Address: VERIZON;PATENT MANAGEMENT GROUP, 1320 North Court House Road, 9th Floor, ARLINGTON, VA, 22201-2909, US

(73) Assignee: Verizon Laboratories Inc., Waltham, MA (US)

(21) Appl. No.: 11/863,372

(22) Filed: Sep. 28, 2007

Related U.S. Application Data
(60) Provisional application No. 60/950,514, filed on Jul. 18, 2007.

(51) Int. Cl. G06Q 99/00; G06F 17/30

(52) U.S. Cl. 705/1

(57) ABSTRACT

A system receives, via a network, customer selected preferences for receiving different types of data at different ones of multiple devices associated with the customer and stores the customer preferences. The system sends a first type of the different types of data to the customer at a first device of the multiple devices based on the stored customer preferences and sends a second type of the different types of data to the customer at a second device of the multiple devices based on the stored customer preferences, where the second device is different than the first device.

### CROSS REFERENCE TO RELATED APPLICATION

This application claims priority to U.S. Provisional Patent Application No. 60/950,514, filed Jul. 18, 2007, the disclosure of which is incorporated by reference herein in its entirety.

### BACKGROUND

The process of searching for real estate has changed drastically over the past few years as web-based services have expanded and improved. According to the National Association of Realtors, 80% of people who bought a home in 2006 used the Internet while house hunting.

### BRIEF DESCRIPTION OF THE DRAWINGS

FIG. 1 is a diagram of multiple devices connected to a network(s) according to an exemplary implementation;

FIG. 2 is a diagram of the transmission of real estate listing data to either of a wireless device, a computer, or a set top box associated with a television;

FIG. 3 is a diagram of a wireless device, computer or set top box according to an exemplary implementation;

FIG. 4 is a diagram that illustrates the aggregation of real estate data according to an exemplary embodiment;

FIG. 5 illustrates a data structure that may be stored in memory in association with the real estate listings server of FIG. 1;

FIG. 6A is a diagram illustrating exemplary realtor listing data included within the data structure of FIG. 5;

FIG. 6B is a diagram that depicts exemplary details of the real estate listing data of FIG. 6A;

FIG. 6C is a diagram that depicts exemplary listing messages stored in an entry of the data of FIG. 6A;

FIG. 7A is a diagram that illustrates exemplary customer listing data included within the data structure of FIG. 5;

FIG. 7B is a diagram that depicts exemplary details of the customer listing data of FIG. 6A;

FIG. 7C is a diagram that depicts exemplary listing messages stored in an entry of the data of FIG. 7A;

FIG. 8 is a flow diagram illustrating an exemplary process for receiving real estate listing data from a realtor/real estate agent and storing the data in the realtor listing data of the data structure of FIG. 5;

FIG. 9 is a flow diagram illustrating an exemplary process for receiving customer preference data and customer saved listing data and storing it in the customer listing data of the data structure of FIG. 5;

FIG. 10A is a diagram of an exemplary user interface that permits a customer to supply the customer's preferences for receiving real estate listing data at various different devices;

FIG. 10B is a diagram of an exemplary user interface that permits the customer to specify what types of real estate listing information the customer desires to receive depending on the device the customer is using to access the real estate listing;

FIG. 11 is a diagram of an exemplary user interface that displays homes and/or properties that a customer has requested be saved and stored for future reference;

FIG. 12 is a flow diagram illustrating an exemplary process for selectively providing real estate listing data and/or data files to a customer according to the customer's stored preferences and based on the customer's access device;

FIG. 13 is a diagram of an exemplary user interface that a customer may use to access the customer's “realtor inbox” that includes real estate listing data stored by a realtor and/or real estate agent;

FIG. 14 is a diagram of an exemplary user interface that displays the contents of a customer's “realtor inbox” when selected by the customer;

FIGS. 15A and 15B are flowcharts of an exemplary process for customer access, at an access device, to listing messages sent from a realtor;

FIGS. 16-21 are diagrams of various exemplary user interfaces of an access device.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

Realtors and/or real estate agents are very interested in establishing a strong web presence to increase the chance of attracting a buyer. Providing real estate listings on devices in addition to a personal computer increases the realtor's chances of finding an interested buyer for their properties and makes it easier for potential homebuyers to find a property that interests them. In exemplary embodiments described herein, a network service provider (e.g., Verizon) provides a mechanism to easily search for, browse, and view real estate listings through multiple different devices, such as a television (TV) set, mobile phone, personal computer, and/or personal digital assistant (PDA). In one implementation, the devices may be connected to a multi-platform network that stores real estate information in a central repository where appropriate listing information can be accessed by each type of device.

Exemplary embodiments described herein expedite the process of searching for a new home, condominium, or apartment, by taking advantage of the unique properties of each device. In addition, exemplary embodiments may provide local advertisers (e.g., realtors) with a more comprehensive system for contacting their customers by way of an inbox for information (e.g., real estate listings) that is accessible via TVs, mobile devices, personal computers and other types of devices. Furthermore, exemplary embodiments provide a source of real estate listing data, and other associated data, that is consistent and comprehensive, and easy to access by customers via many different types of devices.

Exemplary embodiments described herein enable different types of real estate listing content (e.g., data or data files) to be provided to a customer based on the customer's preferences and based on which device the customer is using to access the real estate listing content. For example, the customer may specify that different types of data (e.g., low or high definition images or video) may be provided to the customer based on which device (e.g., wireless device, computer, TV) is using to access the data.

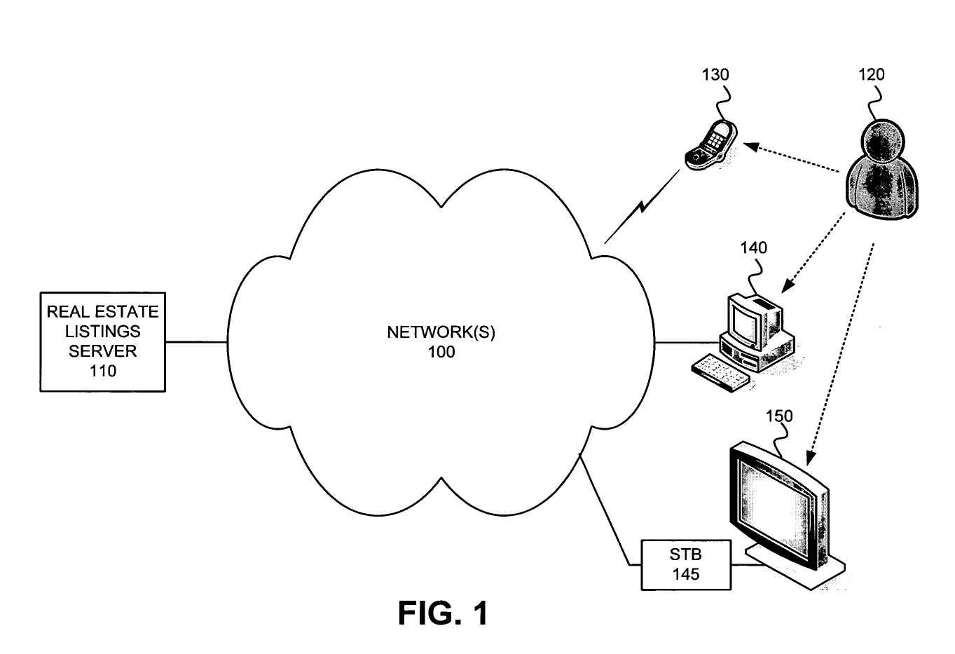

FIG. 1 is a diagram of multiple devices connected to network(s) 100 according to an exemplary implementation. Network 100 may connect to a real estate listings server 110 and multiple devices associated with a given customer 120. For example, as shown in FIG. 1, the multiple devices associated with the customer 120 may include a wireless device 130, a computer 140, and a set top box 145 connected to a television 150. Network(s) 100 may include one or more networks, such as, for example, a local area network (LAN), a wide area network (WAN), a metropolitan area network (MAN), an intranet, the Internet, a wireless satellite network, and/or a wireless public land mobile network (PLMN). Real estate listings server 110 may include a server entity that stores real estate listing information supplied by realtors/real estate agents (or retrieved from a listing service, such as, for example, the multiple listing service (MLS) system) in conjunction with different types of real estate listing data or data files, listing data saved by a customer, and/or a customer's preferences.

Wireless device 130 may include a portable wireless device such as, for example, a wireless personal computer, a wireless telephone, or a wireless personal digital assistant (PDA). Computer 140 may include a wired personal computer such as, for example, a laptop or desktop computer connected to network(s) 100 via a wired link. Instead of, or in addition to, computer 140, the multiple devices of FIG. 1 may include a Voice Over Internet Protocol (VOIP) phone (not shown). STB 145 may include a device that connects television 150 and some external source of signal and which further converts the signal into content that can be displayed on a screen of television 150. The signal may be received via, for example, an ethernet cable, a satellite dish, a coaxial cable (e.g., cable television), a telephone line (including digital subscriber line (DSL) connections), broadband over power line, a very high frequency (VHF) or ultra high frequency (UHF) radio frequency (RF) antenna, or an optical fiber.

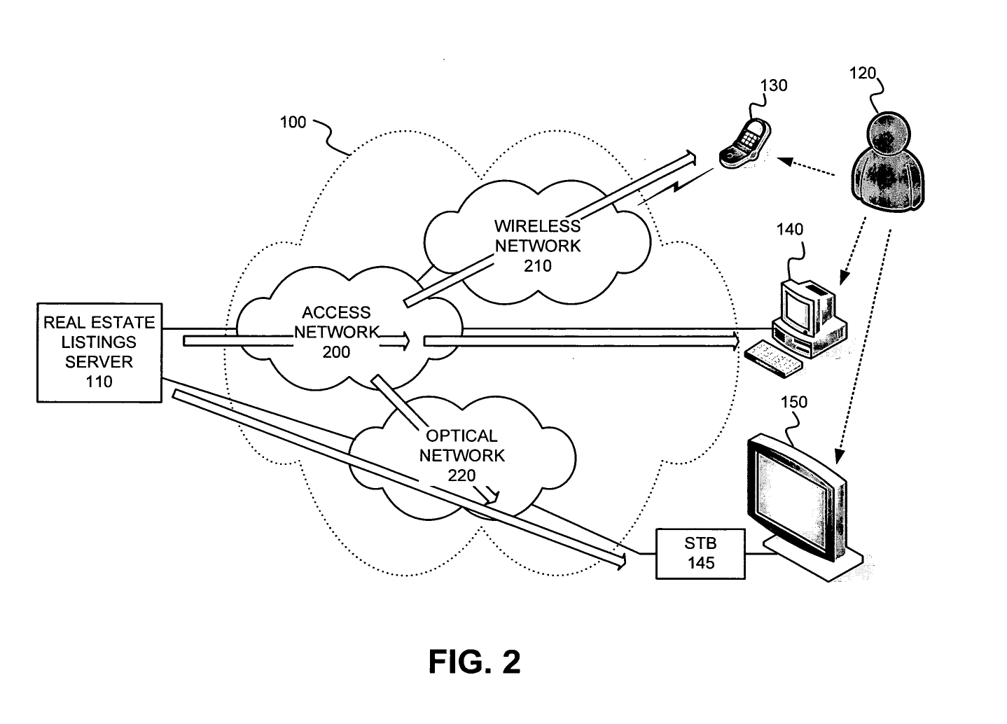

FIG. 2 is a diagram that illustrates the transmission of real estate listing data to either of wireless device 130, computer 140, or STB 145 via one or more of access network 200, wireless network 210 or optical network 220. Access network 200 may include, for example, a local area network (LAN), a wide area network (WAN), a metropolitan area network (MAN), an intranet or the Internet. Wireless network 210 may include a satellite network and/or a public land mobile network (PLMN). The PLMN may further include a General Packet Radio Service (GPRS), a Cellular Digital Packet Data (CDPD), or a Mobile IP network. Optical network 220 may include a network of fiber optic cables. As shown in FIG. 2, real estate listing data may be transmitted to user 120 at device 130, computer 140 or STB 145 via access network 200, wireless network 210, and optical network 220 of network 100. As shown in FIG. 2, real estate listing data may be transmitted via access network 200, and wireless network 210 to user 120 at wireless device 130. As further shown in FIG. 2, real estate listing data may be transmitted via access network 200 to user 120 at computer 140. As additionally shown in FIG. 2, real estate listing data may be transmitted via access network 200 and optical network 220 to user 120 at STB 145, or via optical network 220 to user 120 at STB 145.

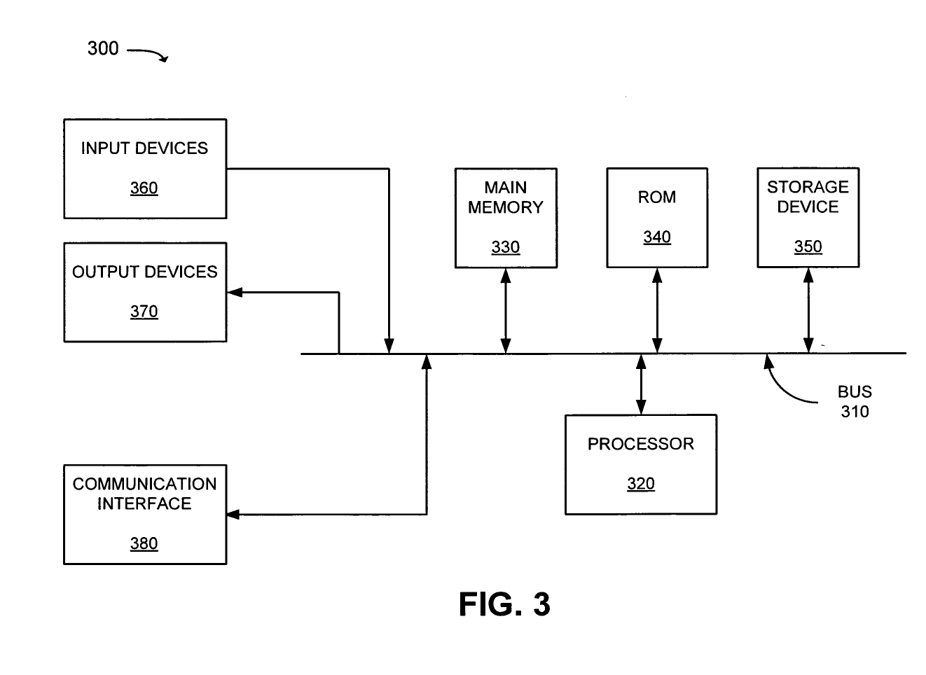

FIG. 3 is a diagram of a device 300 according to an exemplary implementation. Device 300 may represent wireless device 130, computer 140, or STB 145. Device 300 may include a bus 310, a processing unit 320, a main memory 330, a read only memory (ROM) 340, a storage device 350, an input device 360, an output device 370, and a communication interface 380. Bus 10 may include a path that permits communication among the elements of device 300.

Processing unit 320 may include a processor, microprocessor, or processing logic that may interpret and execute instructions. Main memory 330 may include a random access memory (RAM) or another type of dynamic storage device that may store information and instructions for execution by processing unit 320. ROM 340 may include a ROM device or another type of static storage device that may store static information and instructions for use by processing unit 320. Storage device 350 may include a magnetic and/or optical recording medium and its corresponding drive.

Input device 360 may include a mechanism that permits an operator to input information to device 300, such as a keyboard, a mouse, a pen, voice recognition and/or biometric mechanisms, etc. Output device 370 may include a mechanism that outputs information to the operator, including a display, a printer, a speaker, etc. Communication interface 380 may include any transceiver-like mechanism that enables device 300 to communicate with other devices and/or systems. For example, communication interface 380 may include mechanisms for communicating with another device or system via a network. As one example, if device 300 includes wireless device 130, then communication interface 380 may include appropriate mechanisms for communicating with wireless network 210. As another example, if device 300 includes computer 140, then communication interface 380 may include appropriate mechanisms for communicating with access network 200. As a further example, if device 300 includes STB 145, then communication interface 380 may include appropriate mechanisms for communicating with optical network 220.

Device 300 may perform certain operations or processes, as will be described in detail below. Device 300 may perform these operations in response to processing unit 320 executing software instructions contained in a computer-readable medium, such as memory 330. A computer-readable medium may be defined as a physical or logical memory device.

The software instructions may be read into memory 330 from another computer-readable medium, such as data storage device 350, or from another device via communication interface 380. The software instructions contained in memory 330 may cause processing unit 320 to perform operations or processes that will be described later. Alternatively, hardwired circuitry may be used in place of or in combination with software instructions to implement processes consistent with the principles of the invention. Thus, exemplary implementations are not limited to any specific combination of hardware circuitry and software.

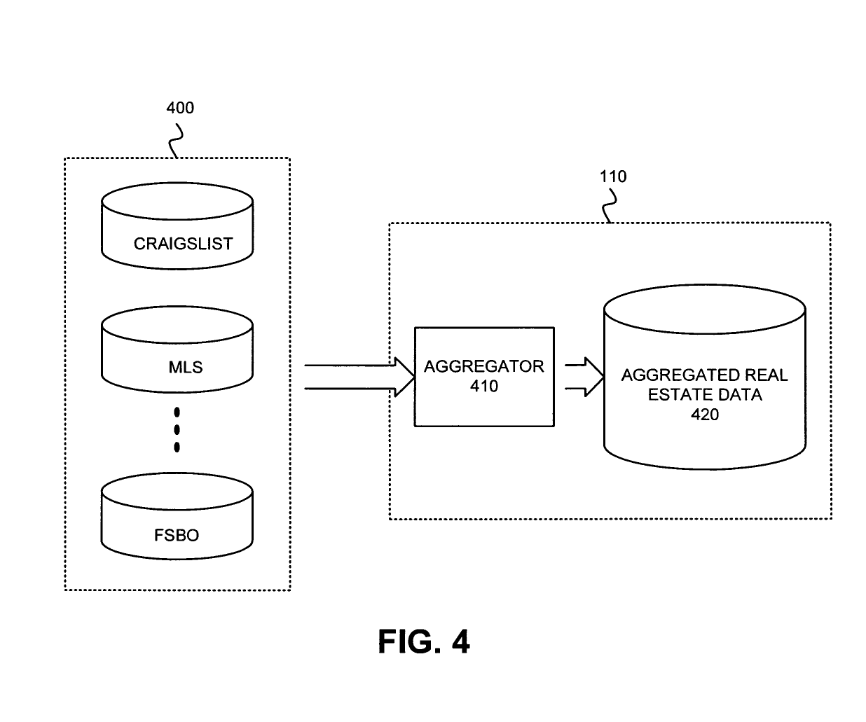

FIG. 4 depicts the aggregation of real estate data by real estate listings server 110 according to an exemplary embodiment. As shown in FIG. 4, real estate listings server 110 may aggregate data from multiple external listing sources 400 that store and/or provide data associated with real estate. In one exemplary embodiment, sources 400 may include one or more websites that host real estate listings/advertisements (e.g., craigslist.org, forsalebyowner.com, fsbo.com) or one or more databases that store multiple listing service (MLS) data. Real estate listing server 110 may include an aggregator 410 and aggregated real estate data 420. Aggregator 410 may, for example, crawl, or otherwise access, real estate data stored at sources 400, aggregate the real estate data, and store the aggregated real estate data in aggregated real estate data 420. Server 110 may aggregate real estate data in other ways, such as by agreement with the operator(s) of sources 400 to provide their data to server 110.

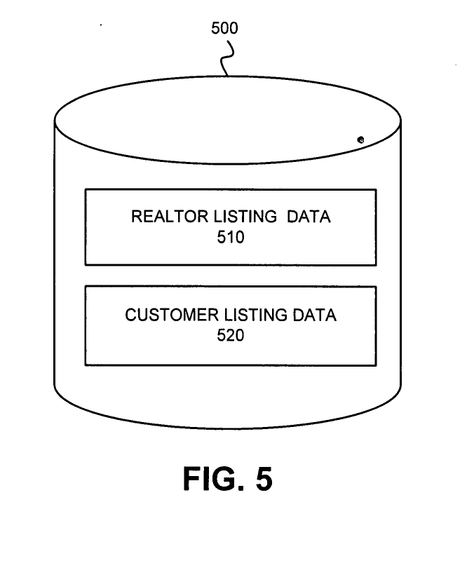

FIG. 5 illustrates a data structure 500 (e.g., a database) that may be stored in memory in association with real estate listings server 110. In one implementation, data structure 500 may be stored in main memory 330. In other implementations, data structure 500 may be stored remotely from real estate listings server 110. Data structure 500 may include realtor listing data 510 and customer listing data 520. Realtor listing data 510 may include data and/or data files provided by one or more realtors or real estate agents to real estate listings server 110. Customer listing data 520 may include data associated with a customer's preferences and data and/or data files selected for saving or storing by the customer.

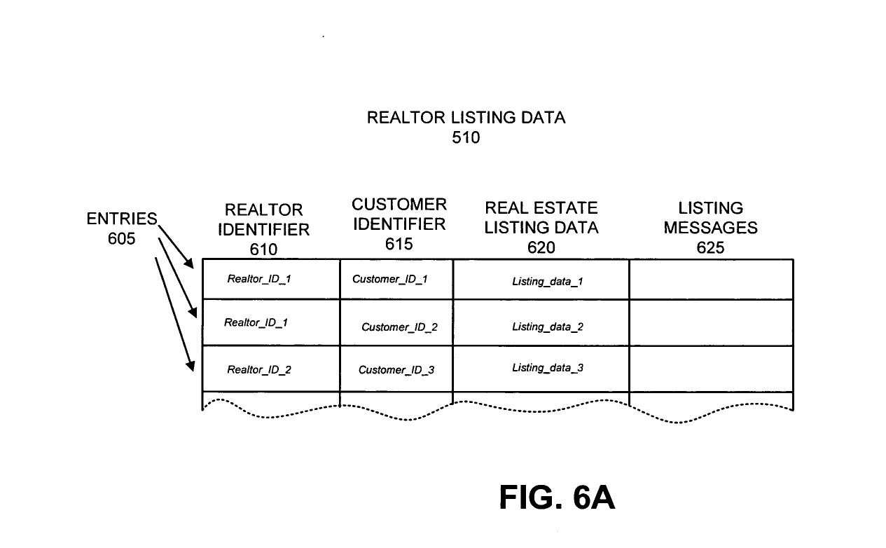

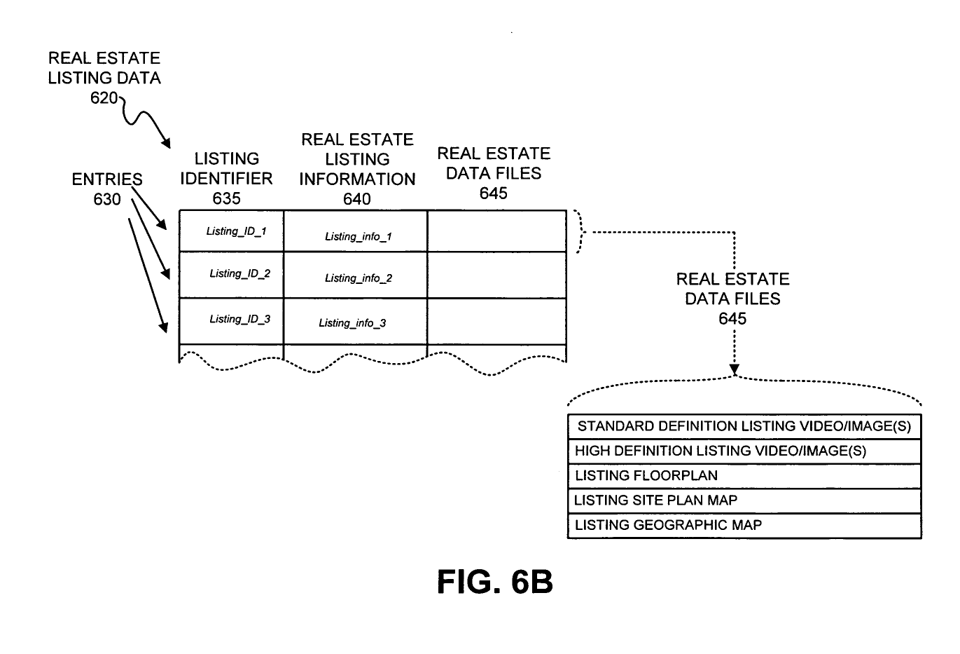

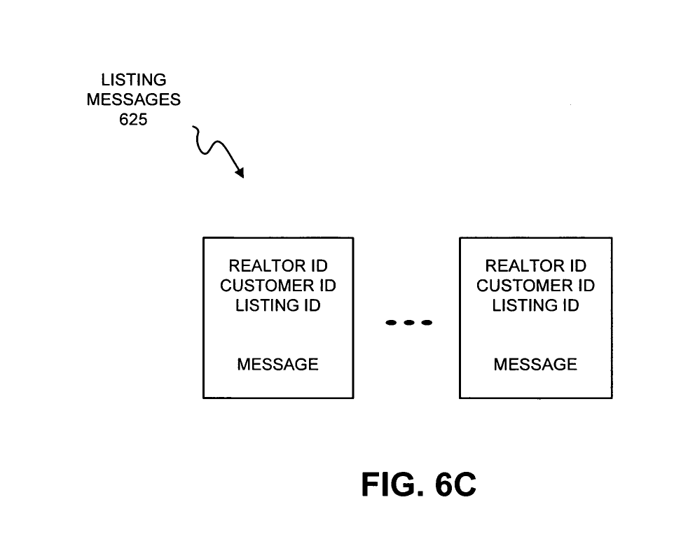

FIG. 6A is a diagram illustrating realtor listing data 510 included within data structure 500. Realtor listing data 510 may be received from a realtor and/or real estate agent via network(s) 100 for storing and future access by one or more customers. Realtor listing data 510 may include multiple entries 605, each of which may further include a realtor identifier 610, a customer identifier 615, real estate listing data 620 and listing messages 625. Realtor identifier 610 may include data that uniquely identifies a realtor/or real estate agent that is providing real estate listing data 620 for storage. Customer identifier 615 may uniquely identify a specific customer (e.g., customer 120). Real estate listing data 620 may include data related to a specific real estate listing. Listing messages 625 may include messages, related to real estate listings, sent from a given customer to the customer's realtor.

As further shown in FIG. 6B, real estate listing data 620 may include multiple entries 630, each of which may include a listing identifier 635, real estate listing information 640, and real estate data files 645. Listing identifier 635 may include data that uniquely identifies a given real estate listing (e.g., a MLS listing number). Real estate listing information 640 may include data that describes a given item of real estate. For example, real estate listing information 640 may include data regarding a specific item of real estate extracted from the multiple listing service (MLS) (e.g., acreage of property, size of home, number of bathrooms, etc.). Real estate data files 645 may include different data files of different types and/or formats that may be provided to a customer interested in a specific item of real estate. For example, real estate data files 540 may include video and/or images of the specific item of real estate in various levels of quality or in various formats. More specifically, in one embodiment, real estate data files 645 may include standard definition video and/or images (e.g., NTSC, PAL, or SECAM) or high definition video and/or images (e.g., HDV, HDTV). The video and/or images may include pictures or video taken on-site at the location of the real estate, a floor plan of a structure located at the real estate, a site plan map of the real estate, or a geographic map associated with a location of the real estate. In some implementations, geographic maps may be obtained from third party sources, such as, for example, Superpages, Google Maps or other geographic information systems (GISs), and may not be stored in association with real estate listing server 110.

As further shown in FIG. 6C, listing messages 625 may include one or more listing messages received from a respective customer. As shown, each listing message may include a realtor identifier that identifies the realtor that the message is being sent to, a customer identifier that identifies the customer who sent the message, a listing identifier that identifies which real estate listing that the message is about, and a message body that includes the content of the customer's message to the realtor.

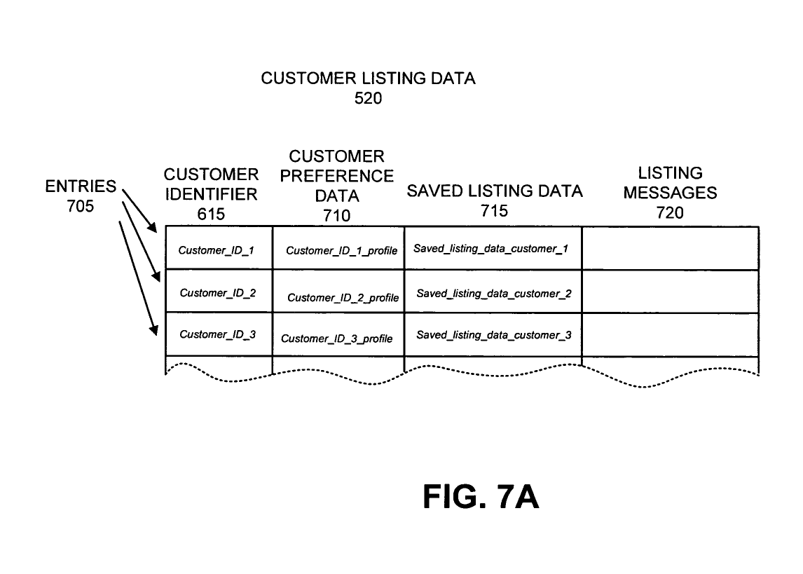

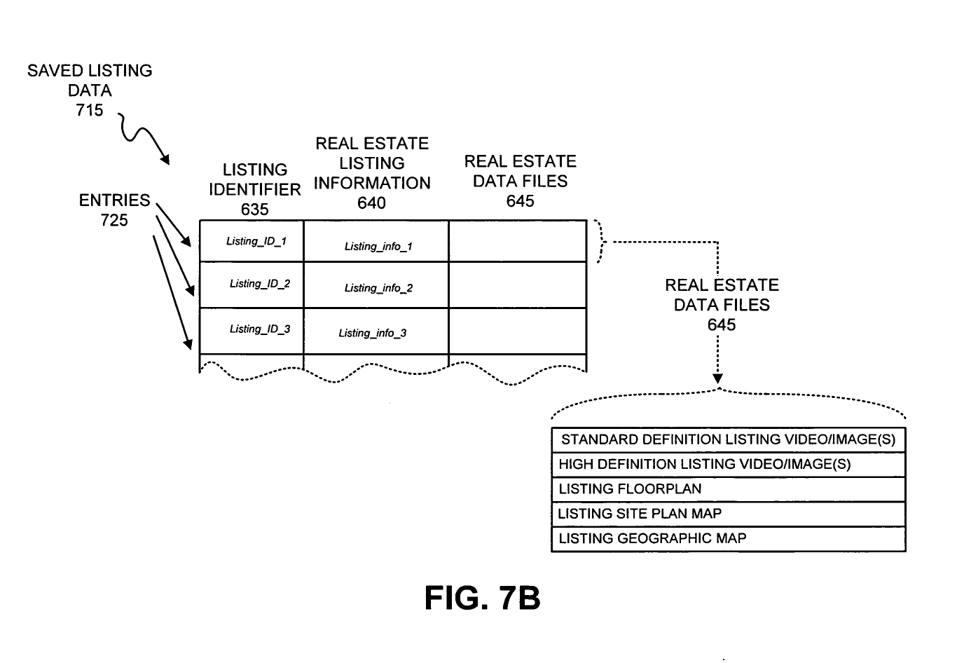

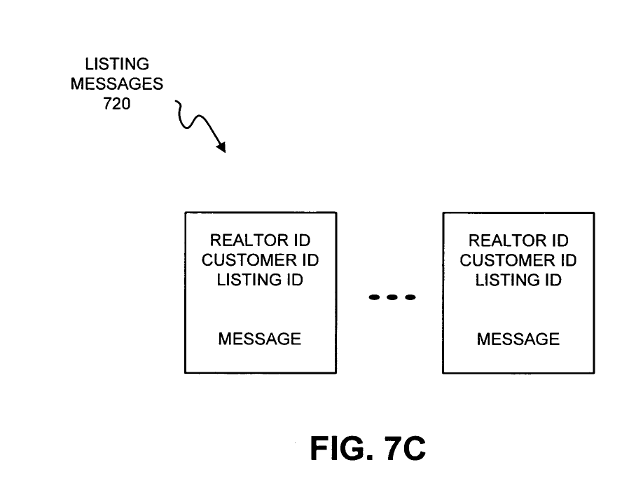

FIG. 7A is a diagram illustrating customer listing data 520 of data structure 500. Customer listing data 520 may be received from a customer (e.g., customer 120) via network(s) 100 for storing and for future access by the customer. Customer listing data 520 may include multiple entries 705, each of which may include a customer identifier 615, a customer profile 710, saved listing data 715 and listing messages 720. Customer profile 710 may include data that details preferences of the customer related to real estate listing information. For example, customer profile 710 may include data that indicates the customer's preferences for content, type and/or format of real estate listing data, or files to be delivered to the customer at the device(s) that the customer may use to access the data. As an example, customer profile 710 may specify that the customer prefers low definition images and/or video to be delivered to the customer when the customer accesses the data via wireless device 130. As a further example, customer profile 710 may specify that the customer prefers high definition images and/or video to be delivered to the customer when the customer accesses the data via STB 145 and TV 150. Saved listing data 715 may include data associated with specific real estate listings that the customer has requested be stored for future reference. Listing messages 720 may include messages, related to real estate listings, sent from a customer's realtor to a given customer.

As further shown in FIG. 7B, saved listing data 715 may include multiple entries 725, each of which may include a listing identifier 635, real estate listing information 640 and real estate data files 645, already described above.

As also shown in FIG. 7C, listing messages 720 may include one or more listing messages received from a customer's realtor. As shown, each listing message may include a realtor identifier that identifies the realtor that the message was sent from, a customer identifier that identifies the customer who the message is intended for, a listing identifier that identifies which real estate listing that the message is about, and a message body that includes the content of the realtor's message to the customer.

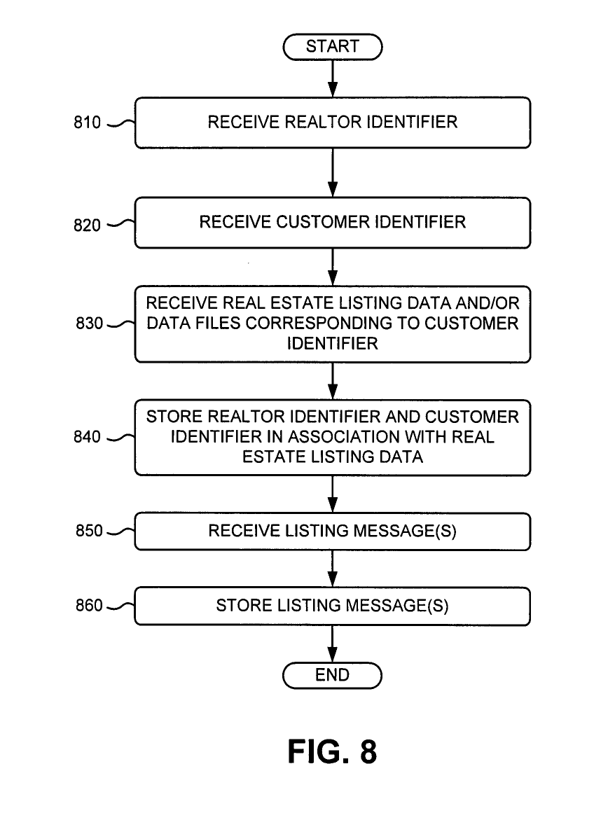

FIG. 8 is a flow diagram illustrating an exemplary process for receiving real estate listing data or listing messages from a realtor or real estate agent and storing the data/messages in realtor listing data 410 of data structure 500. The exemplary process of FIG. 8 may be performed by real estate listings server 110.

The exemplary process may begin with the receipt of a realtor identifier from a realtor or real estate agent (block 810). The realtor or real estate agent may send to real estate listing server 110, via a client computer and network(s) 100, a realtor identifier that uniquely identifies the realtor or real estate agent. A customer identifier may be received from the realtor or real estate agent identifying a specific customer (block 820). The realtor or real estate agent may send, via the client computer and network(s) 100, the customer identifier to real estate listing server 110. The customer identifier may identify the specific customer to whom the realtor or real estate agent wishes to provide real estate listing data and/or data files. Real estate listing data and/or data files corresponding to the customer identifier may be received from the realtor or real estate agent (block 830). The realtor or real estate agent may send to real estate listing server 110, via a client computer and network(s) 100, the real estate listing data and/or data files. The real estate listing data and/or data files may include, among other data or data files, identifiers associated with each of the different real estate listings being provided by the realtor/real estate agent, listing information associated with each real estate listing (e.g., MLS data that describes the item of real estate), and video, images, floor plans, site plan maps or geographic maps associated with each real estate listing.

The realtor identifier and customer identifier may be stored in association with the received real estate listing data in realtor listing data 510 (block 840). For example, real estate listing server 110 may store the received realtor identifier as realtor identifier 610, the received customer identifier as customer identifier 615, and the various received listing identifiers, real estate listing information and data files as listing identifiers 635, real estate listing information 640, and real estate data files 645 in real estate listing data 620 of data structure 500.

A listing message(s) may be received (block 850). The realtor or real estate agent may compose and send a message(s), related to a real estate listing, to a specific customer. The listing message(s) may be stored (block 860) in a listing messages 625 of an entry 605 of data 510 that corresponds to a customer identifier supplied by the realtor or real estate agent.

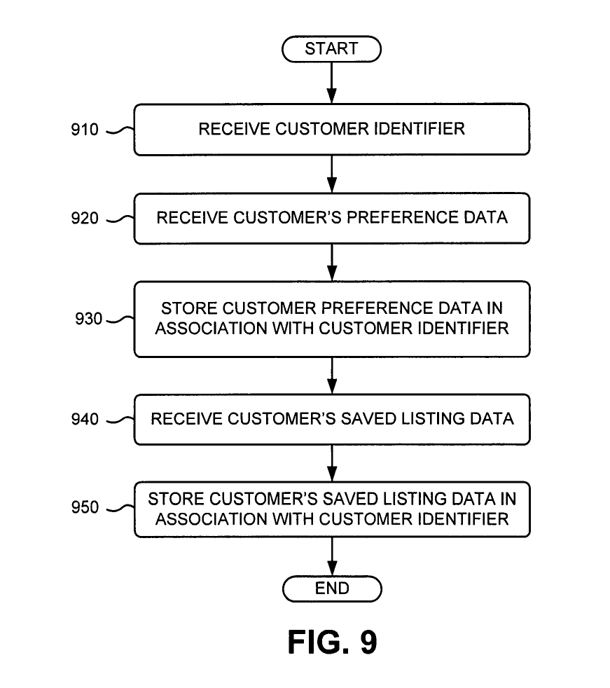

FIG. 9 is a flow diagram illustrating an exemplary process for receiving customer preference data and customer saved listing data and storing it in customer listing data 520 of data structure 500. The exemplary process of FIG. 9 may be performed by real estate listings server 110.

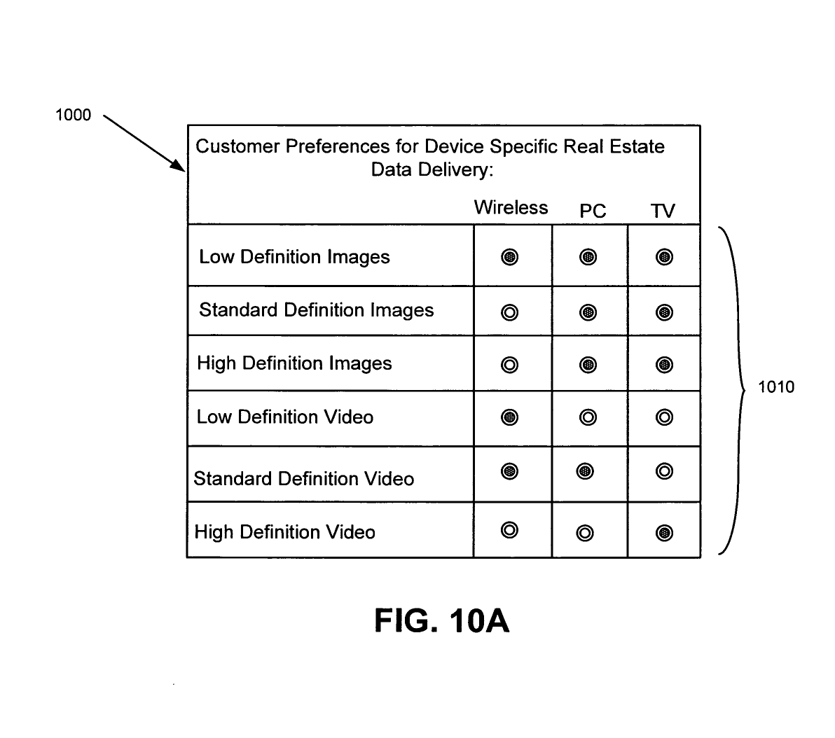

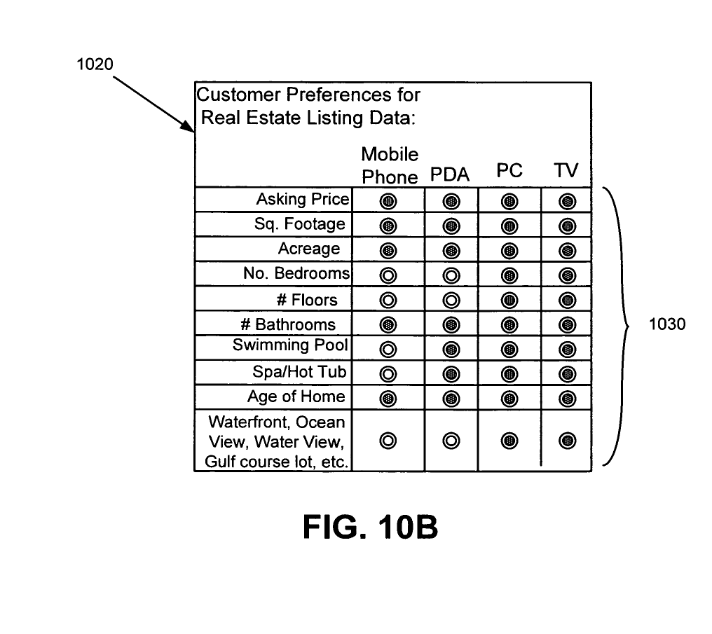

The exemplary process may begin with the receipt of a customer identifier from the customer (block 910). The customer, from either wireless device 130, computer 140, or STB 145 and TV 150, may send the customer's customer identifier to real estate listing server 110 via network(s) 100. The customer's preference data may be received (block 920). For example, in a first exemplary implementation depicted in FIG. 10A, the customer may provide the customer's preferences via a user interface 1000 implemented at wireless device 130, computer 140 or STB 145. The user interface 1000 may display various preferences for data content, data types or data formats that the customer desires to have delivered to the customer based on which one of wireless device 130, computer 140 or STB 145 that the customer is using to access real estate listing information. The customer, via user interface 1000, may select one or more of the various preferences for data content, data types or data formats by, for example, clicking on a respective “check box.” For example, as shown in FIG. 10A, the customer may desire high definition video to be delivered to the customer when the customer accesses real estate listing information via STB 145 and TV 150. As another example, as shown in FIG. 10A, the customer may desire low definition images to be delivered to the customer when the customer accesses real estate listing information via wireless device 130, computer 140 or STB 145 and TV 150.

As another example, in a second exemplary implementation depicted in FIG. 10B, the customer may provide the customer's preferences via a user interface 1020 implemented at wireless device 130, computer 140 or STB 145. The user interface 1020 may display what types of real estate listing information that the customer wants to receive based on which one of wireless device 130, computer 140 or STB 145 that the customer uses to access the real estate listing information. The customer, via user interface 1020, may select one or more of the various preferences for types of real estate listing information by, for example, clicking on a respective “check box.” For example, as shown in FIG. 10B, the customer may desire that asking price, square footage, acreage, number of bathrooms and age of home information be provided to the customer when the customer accesses a specific real estate listing via a mobile phone. Since mobile phones typically have limited screen display space, setting customer preferences as shown in FIG. 10B permits the most important listing information to be displayed on the limited display space of the customer's mobile phone. As further shown in FIG. 10B, the customer may desire that asking price, square footage, acreage, number of bathrooms, swimming pool, spa/hot tub, and age of home information be provided to the customer when the customer access a specific real estate listing via a PDA. User interface 1020, thus, may permit the customer to specify what types of information the customer desires to receive depending on the device the customer is using to access the real estate listing. In another exemplary implementation, the customer may set preferences for an individual device. For example, the customer may set preferences for receiving certain types of listing information (e.g., asking price, acreage, number of bathrooms, etc.) at a specific access device. In this implementation, the customer may receive a first set of listing information when accessing the listing information at a first mobile phone and receive a different, second set of listing information when accessing the listing information at a second mobile phone. The customer's preference data may be stored in association with the received customer identifier in the customer's listing data (block 930). For example, the received customer preference data may be stored as customer preference data 710 in association with the received customer identifier stored as customer identifier 615 in customer listing data 520.

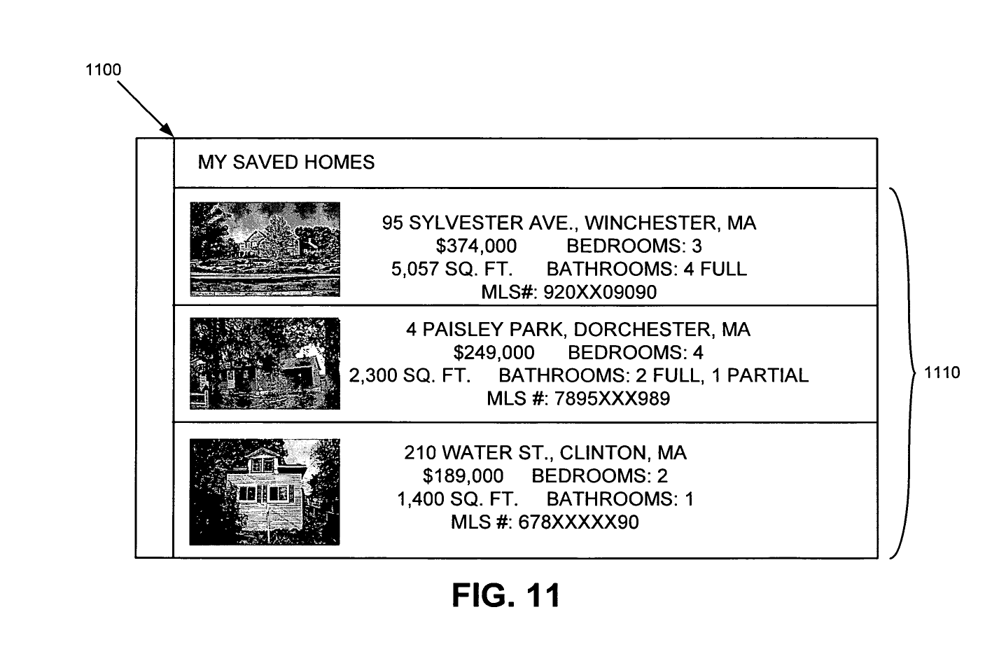

The customer's saved listing data may be received (block 940). Customer 120 may perform a search of real estate listings via, for example, the MLS system, and may request that the results of that search be saved. For example, as shown in FIG. 11, customer 120, via user interface 1100 implemented at one of wireless device 130, computer 140 or STB 145 and TV 150, may select multiple real estate listings 1110 for storing at real estate listing server 110. The customer's saved listing data may be stored in association with the received customer identifier in customer listing data 520 (block 950). For example, the customer's designated saved listing data may be stored in saved listing data 715 in association with the customer's customer identifier 615 in customer listing data 520 of data structure 500. The saved listing data 715 stored by the customer may include listing identifiers 635, real estate listing information 640 (e.g., MLS listing information) and/or real estate data files 645, including, for example, video, images, floor plans, site plan maps and/or geographic maps.

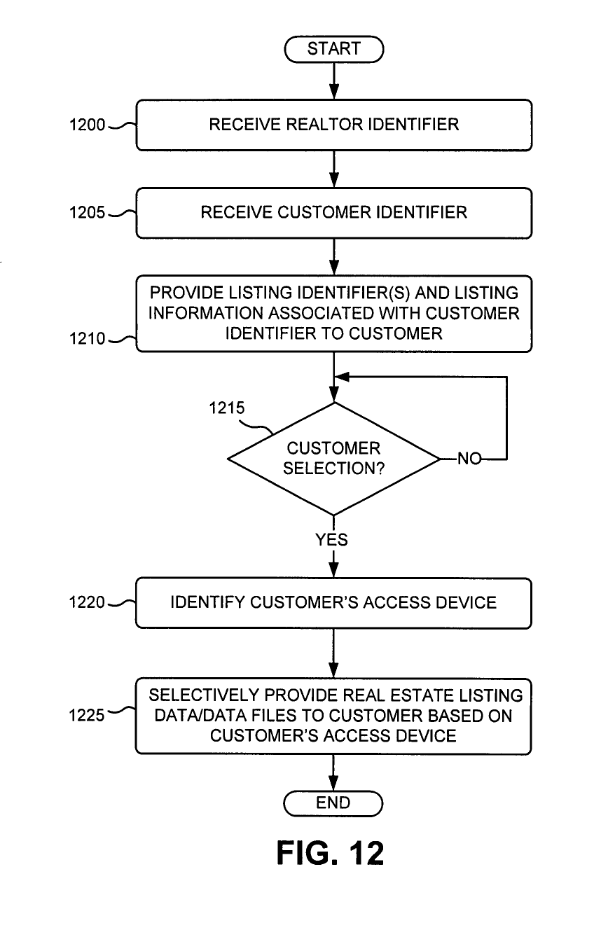

FIG. 12 is a flow diagram of an exemplary process for providing real estate listing data or data files to a customer based on the customer's stored preferences and based on the customer's device used to access the data or data files. The exemplary process of FIG. 12 may be performed by real estate listing server 110.

The exemplary process may begin with the receipt of a realtor identifier (block 1200). Customer 120 may provide to real estate listing server 110, via one of wireless device 130, computer 140 or STB 145 and TV 150 and network(s) 100, a known identifier associated with the customer's realtor or real estate agent. A customer identifier may be received (block 1205). Customer 120 may additionally provide to real estate listing server 110, via wireless device 130, computer 140 or STB 145 and TV 150 and networks(s) 100, the customer's own unique identifier. Real estate listing server 110 may use the received realtor identifier and customer identifier to access realtor listing data 510 of data structure 500 to retrieve corresponding real estate listing data 620.

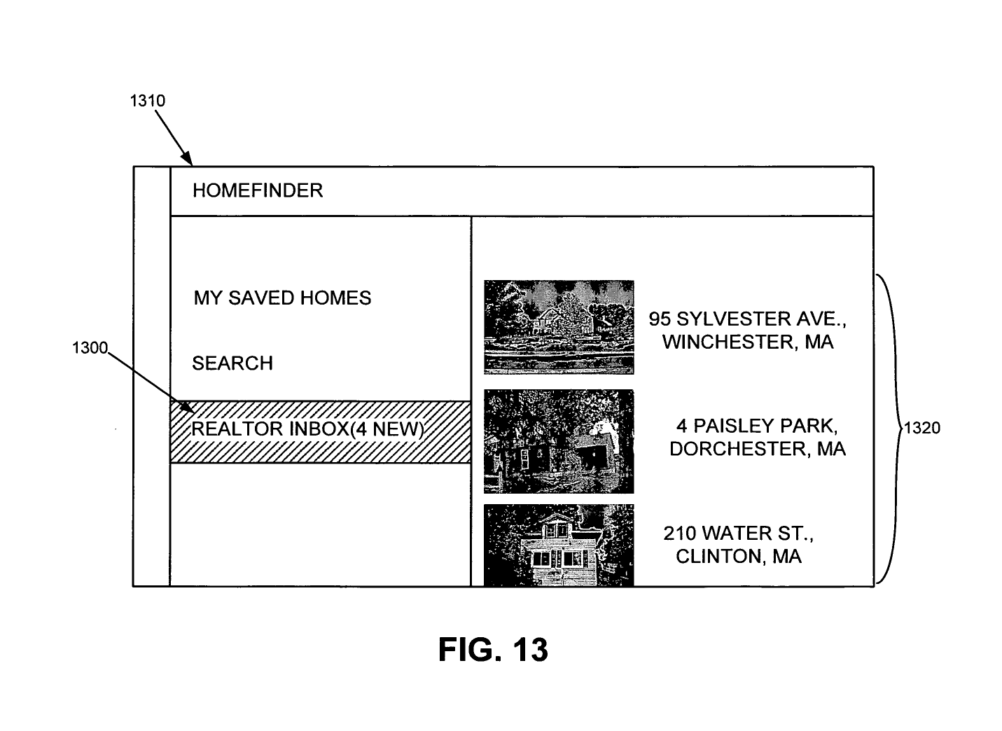

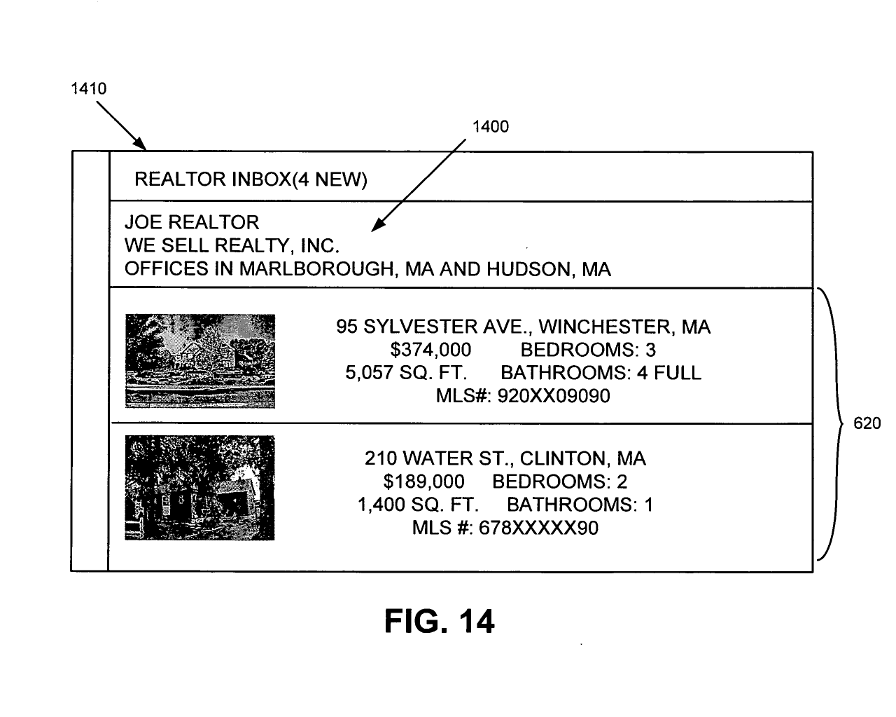

A listing identifier(s) and listing information associated with the received customer identifier may be provided to the customer (block 1210). Real estate listing server 110 may retrieve one or more listing identifiers 635, and at least a snippet of information from corresponding real estate listing information 640, and provide the identifier's and listing information to the customer at the wireless device 130, computer 140 or STB 145 that the customer is currently using. For example, as shown in FIG. 13, customer 120 may access, using the customer's identifier and the identifier of the customer's realtor, a “realtor inbox” 1300 via a user interface 1310 at wireless device 130, computer 140 or STB 145 and TV 150. Selection of “realtor inbox” 1300 by the customer may result in the display of realtor/real estate agent information 1400 and corresponding portions of real estate listing data 620 in user interface 1410 as shown in FIG. 14. Customer 120 may subsequently select a listing from the “realtor inbox” of user interface 1410 for accessing additional data and/or data files associated with the real estate listing.

If the customer selects a listing from the received listing identifier(s) (block 1215), real estate listing server 110 may then identify the customer's access device (block 1220). Real estate listing server 110 may identify what kind of device that the customer is using to access the real estate listing (e.g., wireless device 130, computer 140, STB 145). Once the customer's access device is identifier, real estate listing data/data file(s) may be selectively provided to the customer based on the customer's access device (block 1120). In one implementation, real estate listing server 110 may determine which types and/or formats of data to send to the customer based solely on the customer's access device type that is identified by server 110. In this implementation, real estate listing server 110 may implicitly send appropriate real estate files 645 in a type and/or format that is optimized for the access device type. For example, real estate listing server may recognize that a mobile phone cannot display high definition video and may instead send the mobile phone low or standard definition video.

In another implementation, real estate listing server 110 may determine which types and/or formats of data to send to the customer based on the customer's preference data 710 and based on the customer's access device. In this implementation, real estate listing server 110 may access the customer's customer preference data 710, and may then access real estate listing data 620 to retrieve real estate listing information 640 and appropriate real estate files 645 based on customer preference data 710 and based on which device of wireless device 130, computer 140 or STB 145 and TV 150 that the customer is using to access the listing data. For example, if the customer's customer preference data 710 indicates that the customer prefers to be delivered high definition video when the customer accesses listing data via STB 145 and TV 150, then real estate listing server 110 may retrieve high definition video from data files 645 and provide it to customer 120 via network(s) 110. As another example, if the customer's preference data 710 indicates that the customer prefers to be delivered standard definition images when the customer accesses listing data via computer 140, the real estate listing server 110 may retrieve standard definition images from data files 645 and provide it to customer 120 via network(s) 110.

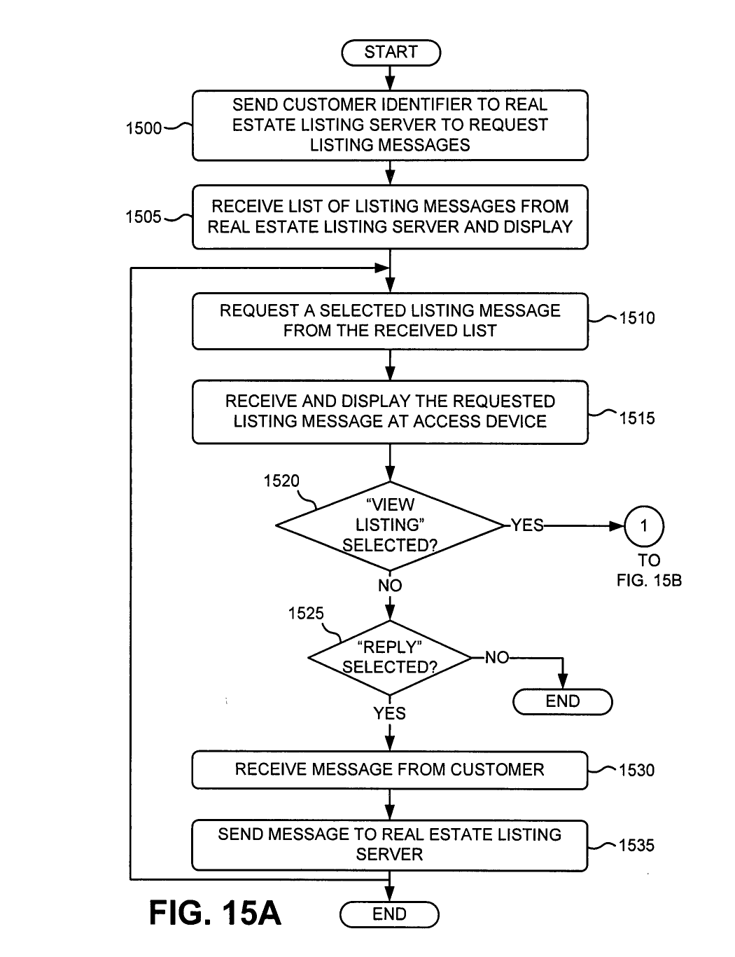

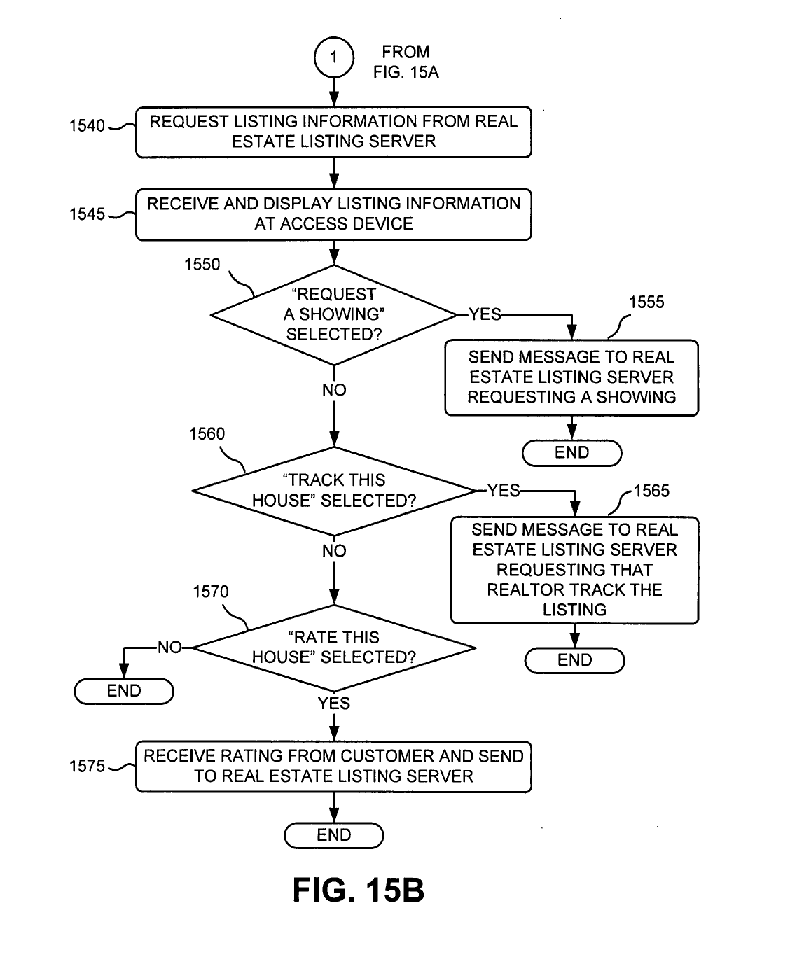

FIGS. 15A and 15B are flow diagrams of an exemplary process for customer access, at an access device (e.g., wireless device 130, PC 140 or STB 145), to listing messages sent from a realtor. The exemplary process of FIGS. 15A and 15B may be performed by wireless device 130, computer 140 or STB 145, referred to in the following process as the “access device.”

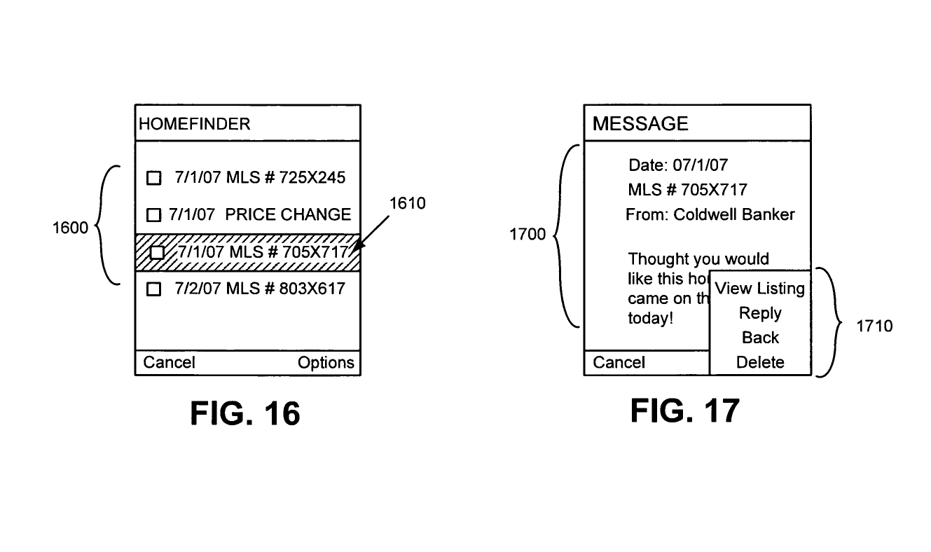

The exemplary process may begin with a customer sending their customer identifier to real estate listing server 110 to request access to the customer's listing messages (block 1500). In response, real estate listing server 110 may access an entry 705 of customer listing data 520, that has a customer identifier 615 that is the same as the customer identifier sent by the customer, to retrieve a list of listing messages 720. The list of listing messages may be received from real estate listing server 110 and displayed at the access device (block 1505). For example, as shown in FIG. 16, the access device may display a list 1600 of listing messages sent by the customer's realtor. The customer may select 1610 one of the listing messages for display of the message contents.

A selected listing message from the received list may be requested (block 1510). The access device may, for example, send a request to real estate listing server 110 requesting retrieval of the customer selected listing message. The requested listing message may be received and displayed at the access device (block 1515). The access device may, for example, receive the requested listing message from real estate listing server 110 and display the contents of the message. For example, as shown in FIG. 17, the contents 1700 of a listing message may be displayed at the access device.

A determination may be made whether “view listing” has been selected by the customer at the access device (block 1520). For example, as shown in FIG. 17, an “options” list 1710 may be selected by the customer at the access device and a list of available options that the customer may select may be presented to the customer. The customer may then select the “view listing” option from list 1710. If “view listing” hasn't been selected by the user, then a determination may be made whether “reply” has been selected by the customer (block 1525). For example, the customer may select the “reply” option from “options” list 1710 at the access device. If “reply” has been selected by the customer, then a message may be received from the customer (block 1530). The customer may enter, for example, a text message intended for the customer's realtor via a keypad or keyboard of the access device. The received message may be sent to real estate listing server 110 (block 1535). Real estate listing server 110 may store the message in listing messages 625 of realtor listing data 510 for future access by the realtor.

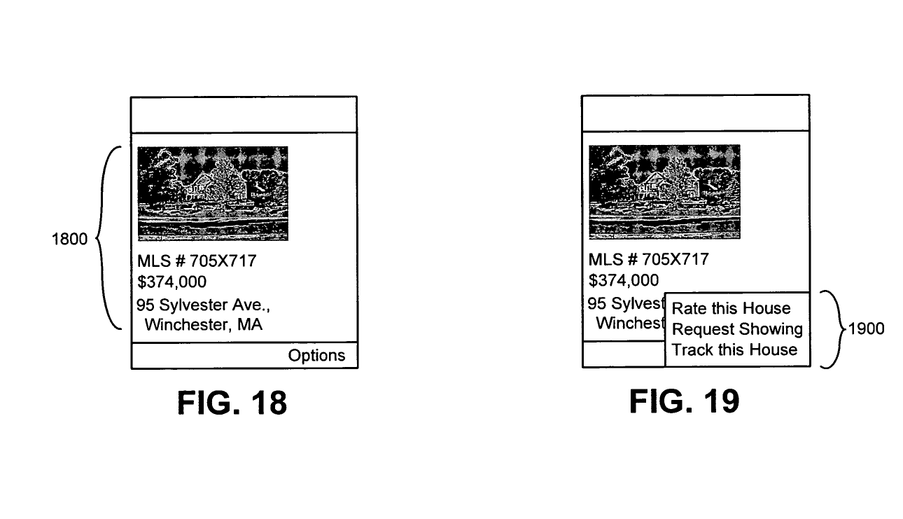

Returning to block 1520, if “view listing” has been selected by the customer, then listing information may be requested from real estate listing server 110 (block 1540). The requested listing information may include information specific to the listing contained in the original message from the realtor to the customer. The requested listing information may be received at the access device and displayed (block 1545). For example, as shown in FIG. 18, listing information 1800 associated with a specific real estate listing may be displayed at the access device.

A determination may be made whether “request a showing” has been selected (block 1550). For example, as shown in FIG. 19, an “options” list 1900 may be selected by the customer at the access device and a list of available options that the customer may select may be presented to the customer. The customer may select the “request a showing” option from list 1900. If “request a showing” has been selected by the customer, a message may be sent to real estate listing server 110 requesting a showing (block 1555). Real estate listing server 110 may store the message in listing messages 625 for access by the customer's realtor. If “request a showing” has not been selected, then a determination may be made whether “track this house” has been selected (block 1560). For example, the “track this house” option may be selected from options list 1900 at the access device. If “track this house,” has been selected by the customer, then a message may be sent to real estate listing server 110 requesting that the customer's realtor track the listing (block 1565). Real estate listing server 110 may store the message in listing messages 625 for access by the customer's realtor. In response to receipt of this message, the customer's realtor may track the corresponding real estate to identify if the seller lowers the price, if the seller has the property under contract, etc.

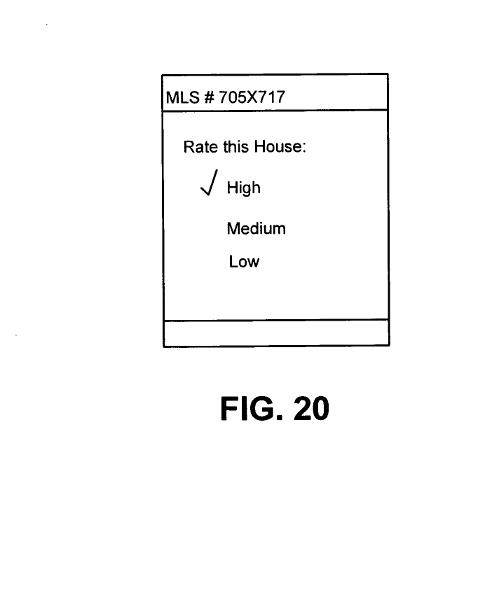

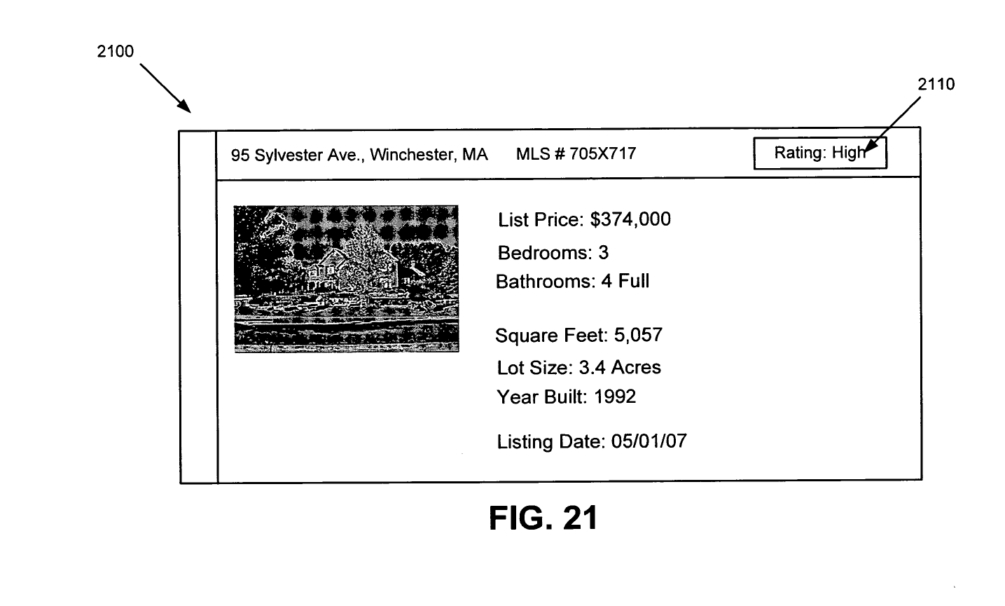

If “track this house” has not been selected, then a determination may be made whether “rate this house” has been selected (block 1570). For example, the “rate this house” option may be selected from options list 1900 at the access device. If “rate this house” has been selected, a rating may be received from the customer and sent to real estate listing server 110 (block 1575). For example, as shown in FIG. 20, the customer may select a rating to be associated with this real estate listing. This rating may be supplied to the customer when the customer subsequently accesses the same real estate listing again. For example, as shown in FIG. 21, when the customer subsequently accesses the listing 2100, a rating value 2110, may be displayed along with the listing.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. Modifications and variations are possible in light of the specification, or may be acquired from practice of the invention. For example, while a series of blocks has been described with regard to FIGS. 8, 9, 12, 15A and 15B, the order of the blocks may be modified in other implementations consistent with the principles of the invention. Further, non-dependent blocks may be performed in parallel. Implementations have been described for providing different types or format of real estate listing data to customers based on the kind of device that the customer uses to access the real estate listing data. Implementations described herein may also be applied to data used by travel agents, dating services, etc.

It will be apparent that embodiments, as described above, may be implemented in many different forms of software, firmware, and hardware in the implementations illustrated in the figures. The actual software code or specialized control hardware used to implement embodiments is not limiting of the invention. Thus, the operation and behavior of the embodiments have been described without reference to the specific software code, it being understood that software and control hardware may be designed based on the description herein.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
receiving, via a network, customer selected preferences for receiving different types of data at different ones of multiple devices associated with the customer;
storing the customer preferences;
sending a first type of the different types of data to the customer at a first device of the multiple devices based on the stored customer preferences; and
sending a second type of the different types of data to the customer at a second device of the multiple devices based on the stored customer preferences, where the second device is different than the first device.

2. The method of claim 1, further comprising:
receiving a request from the customer to access the data; and
sending the first or the second type to the customer at the first or second devices based on the request.

3. The method of claim 1, where the data comprises real estate listing data.

4. The method of claim 1, where the first type comprises standard definition video and/or images.

5. The method of claim 4, where the second type comprises high definition video and/or images.

6. The method of claim 1, where the customer selected preferences specify what type of data of the different types of data should be sent to the customer at the first device and what type of data of the different types of data should be sent to the customer at the second device.

7. The method of claim 1, where the first device comprises a mobile wireless device and where the second device comprises a set top box associated with a television.

8. The method of claim 7, where the mobile wireless device comprises a wireless telephone, a wireless computer or a wireless personal digital assistant (PDA).

9. The method of claim 1, where the first device comprises a mobile wireless device and where the second device comprises a personal computer or Voice Over Internet Protocol (VOIP) phone.

10. The method of claim 1, where the first device comprises a personal computer and where the second device comprises a set top box associated with a television.

11. The method of claim 10, where the television comprises a high definition television (HDTV).

12. A system, comprising:
an interface to receive, via a network, customer selected preferences for receiving different types of real estate listing data at different ones of multiple devices associated with the customer, where the customer selected preferences specify what type of data of the different types of real estate listing data should be sent to the customer at a first device of the multiple devices and what type of data of the different types of real estate listing data should be sent to the customer at a second device of the multiple devices;
a memory to store the customer preferences;
a processing unit to:
initiate sending a first type of the different types of real estate listing data to the customer at the first device of the multiple devices based on the stored customer preferences, and
initiate sending a second type of the different types of real estate listing data to the customer at the second device of the multiple devices based on the stored customer preferences, where the second device is different than the first device.

13. The system of claim 12, where the first type comprises standard definition video and/or images.

14. The system of claim 13, where the second type comprises high definition video and/or images.

15. The system of claim 12, where the first device comprises a mobile wireless device and where the second device comprises a set top box associated with a television.

16. The system of claim 15, where the mobile wireless device comprises a wireless telephone, a wireless computer or a wireless personal digital assistant (PDA).

17. The system of claim 12, where the first device comprises a mobile wireless device and where the second device comprises a personal computer.

18. The system of claim 12, where the first device comprises a personal computer and where the second device comprises a set top box associated with a television.

19. The system of claim 18, where the television comprises a high definition television (HDTV).

20. The system of claim 12, where the interface is further configured to receive one or more messages associated with a real estate listing sent from a real estate agent to the customer and where the memory is further configured to store the one or more messages.

21. The system of claim 20, where the processing unit is further configured to:
permit the customer to access at least one of the one or more messages, and
initiate sending of data associated with the real estate listing to the customer based on the customer accessing the at least one of the one or more messages.

22. A method, comprising:
storing real estate listing data, where the real estate listing data comprises different types of listing information;
receiving, via a network, customer selected preferences for receiving different types of listing information at different ones of multiple devices associated with the customer;
storing the customer preferences;
sending first types of the different types of listing information to the customer at a first device of the multiple devices based on the stored customer preferences; and
sending second types of the different types of listing information to the customer at a second device of the multiple devices based on the stored customer preferences, where the second device is different than the first device and where at least one of the first types is different than at least one of the second types.

23. The method of claim 22, where the different types of listing information comprise an asking price, a square footage, an acreage, a number of bedrooms, a number of floors, a number of bathrooms, a swimming pool, a spa/hot tub, or an age of home associated with a real estate listing.

24. The method of claim 23, where the first types comprise a first subset of the different types of listing information and where the second types comprise a second subset of the different types of listing information, where the first subset is different than the second subset.
